(19) United States
(12) Patent Application Publication
(10) Pub. No.: US 2014/0370844 A1
(43) Pub. Date: Dec. 18, 2014

(54) METHOD FOR THE AUTOMATIC DETECTION AND LABELLING OF USER POINT OF INTEREST

(71) Applicant: Telefonica, S.A., Madrid (ES)

(72) Inventors: Ruben Lara, Madrid (ES); Rocio Martinez, Madrid (ES); Miguel Angel Rodriguez, Madrid (ES); Alberto Martin, Madrid (ES); Ana Armenta, Madrid (ES)

(73) Assignee: TELEFONICA, S.A., Madrid (ES)

(21) Appl. No.: 14/373,565

(22) PCT Filed: Jan. 8, 2013
(86) PCT No.: PCT/EP2013/050225

§ 371 Date: Jul. 21, 2014

(30) Foreign Application Priority Data
Jan. 20, 2012 (ES) P201230075

(51) Int. Cl. H04W 4/02

(52) U.S. Cl. CPC H04W 4/028
USPC 455/405

(57) ABSTRACT

The method comprises acquiring information from signals exchanged between a user's mobile computing devices and a plurality of Base Transceiver Stations, or BTSs, analyzing said acquired information for determining, over a period of time, the locations of said user's mobile computing device and deduce through a statistical model the points of interest, identifying and labelling at least part of said user's mobile computing device determined locations as points of interest.

### FIELD OF THE ART

The present invention generally relates to a method to automatically detect and label one or more points of interest (Pols) of a user of mobile phone services, said method based exclusively on geo-located phone usage information and with no customer interaction. Based on the geo-located usage events generated in the telecommunications operator network and using statistical methods, the invention allows the identification of, from all the locations visited by the user, the locations that are most relevant to him: his Pols. Moreover, the invention automatically assigns labels to the Pols detected, thereby attaching meaning to such locations.

### BACKGROUND OF THE INVENTION

The study of human mobility patterns has received growing attention over the past few years, especially due to the increasing availability of location data coming from both global positioning systems (GPS) and mobile telephone usage, which leaves geo-located traces on the operators' networks.

Understanding how and when human movements take place across towns, cities or countries is of interest in many areas, such as traffic management, transport network design or diseases spread control. However, not only a global view of population flows, but also individual mobility patterns of a user, are of great interest in a number of fields. The knowledge of what locations a user periodically visits, over what period, with what frequency, what days of the week and at what times of the day, etc. can be exploited for the provision of contextual services, relevant advertising, targeted offers to address the particular mobility needs of the user, itinerary planning. In general, knowing locations that are relevant for a user can enable the personalisation of commercial communications or service interactions and improve their relevance.

In order to estimate Pols needs to be assumed that human movements follow some pattern and, thus, the location of a user is to some extent predictable. In this sense, several authors have recently worked on the predictability of human mobility patterns trying to find the limits of such predictability. Based on the study of the trajectory of 100,000 anonymised mobile phone users whose position was tracked for a six-month period, it was found in [1] that human trajectories show a high degree of temporal and spatial regularity, each individual being characterized by a time-independent characteristic travel distance and a significant probability to return to some few highly frequented locations.

Reference [2] tried to answer the question of “to what degree is human behavior predictable?” by studying the mobility patterns of anonymised mobile phone users. The authors measured the entropy of each individual's trajectory, and found a 93% potential predictability in user mobility across the whole user base. They also found a remarkable lack of variability in predictability, largely independent of the distance users cover on a regular basis.

Location prediction models developed in the recent years take into account individual and collective behaviours. As for example [3], where a model was based on the person's past trajectory and the geographical features of the area where the collectivity moved, both in terms of land use, points of interests and distance of trips.

The prediction method can be addressed in different ways. [4] for example presents a location and dwell time prediction using kernel density estimation based on communication, proximity, location, and activity information of the subjects.

Collective communication behavior has also been used to detect the occurrence of anomalous events as in [5] where they study how spatiotemporal anomalies can be described using standard percolation theory tools.

Human mobility patterns have also been inferred from GPS traces [6] where a clustering method is proposed to extract the main points of interest, called geo-locations, from GPS data. Starting from geo-locations they propose a definition of community, the geo-community, which captures the relation between a spatial description of human movements and the social context where users live. A statistical analysis of the principal characteristics of human walks provides the fitting distributions of distances covered by people inside a geo-location and among geo-locations and pause time. They also analyze factors influencing people when choosing successive locations in their movement.

Reference [7] discloses study mobility in an activity-aware map that describes the most likely activity associated with a specific area of space. This allows them to capture the individual daily activity pattern and analyze the correlations among different people's work area's profile. For this purpose they understand the work location of each user as the most frequent stop during day hours. Based on a large mobile phone data of nearly one million records of the users in the central Metro-Boston area, they find a strong correlation in daily activity patterns within the group of people who share a common work area's profile. In addition, within the group itself, the similarity in activity patterns decreases as their work places become apart

Some authors [8] focus on Human Centered Mobility Models, that is, how social networks and mobility patterns match together, trying to extend the social network mobility to the geographical movements, which they call “opportunistic networks”.

So, the scientific community is working and researching around human mobility as a topic, and several approaches yield to better knowledge of different aspects of human mobility, but from the perspective of its exploitation for personalisation, what matters most to us is to know when and for what purpose users frequently visit certain locations, that is, what are the points of interest of users.

Different inventions work on the topic of Pols for different purposes:

The document US2010121803 “Predictive ephemeral Points of Interest” wireless application users are provided with the ability to record locations and retrieve maps of past locations and predicted future locations of specific interest. Within this invention, to predict a location, data about previous reported locations are gathered, and statistical analysis is used to present a visual guide to finding the Pols at a particular time in the future.

The document WO2011076988 “Methods and apparatus for grouping points of interest according to area names” an approach is provided for crowd sourcing and grouping point-of-interest based on cell broadcast message information. Reception of a message from a mobile terminal is caused, at least in part. The message specifies point-of-interest information and an associated area name corresponding to one of a plurality of cells of a communication network. The message is parsed to determine the point-of-interest information and the associated area name.

The document WO2011072882 a method for evaluating an attribute of a point of interest comprises associating a region with the point of interest and evaluating the attribute according to a comparison of position data of a plurality of users with position data defining the associated region.

The document US2011166957 “Biasing of search result clustering to ensure more effective point of interest targeting”: Directory service results responsive to a request for a desired good or service provider may be provided based on one or more user-selected locations. The user may seek a desired good or service provider that is close to a location from which the user may begin travelling to the point of interest, referred to as a source location, and satisfies a beneficial objective by the user (a directional travel preference for instance).

The document US2010023259 “Discovering points of interest from users map annotations” A method that facilitates generating a point of interest related to a map. An interface component can collect a portion of annotation data from two or more users, wherein the portion of annotation data is associated with a digital map and includes at least one of a map location and a user specific description of the map location. An annotation aggregator can evaluate annotation data corresponding to the map location on the digital map. The annotation aggregator can create a point of interest for the map location based upon the evaluation and populates the digital map with at least one of an identified location extracted from two or more users.

The document US2003191578 “Method and System for providing reminders about points of interests while travelling” A navigation system includes a feature that allows a user to specify a type of point of interest and then receive a reminder when the user is in proximity to a location of the point of interest of the specified type while travelling in a geographic region.

The document US2009097710 “Methods and system for communication and displaying points-of-interest” A method for displaying point-of-interest coordinate locations in perspective images and for coordinate-based information transfer.

The document US2008076451 “Point of Interest Spatial Rating Search Method and System ” A system and method for searching and retrieving location information associated with one or more points of interests, whereby the search criteria can be dependent upon the location of a point of interest with respect to the real-time position of the user, and any preferences or search restrictions selected by the user, such as rating information about the point of interest.

The document U.S. Pat. No. 7,890,254 “Point of Interest Display System” A point of interest display system includes an updateable database which interfaces with a microprocessor which receives data from a GPS receiver providing the system with current vehicle location and direction of travel information.

The document US2004236504 “Vehicle Navigation Point Of Interest” The present invention provides a navigation system for assisting locating points of interest during vehicle navigation. The system includes a processor enabled by software to receive and store a user selection of preferred visitation points and a user selected time and to determine and indicate a subset of the preferred visitation points that are located within a predetermined location relative to the vehicle position at the user selected time or relative to a selected destination.

The document US2011125359 “Navigation Apparatus, Server Apparatus and Method of Providing Point of Interest Data” A navigation apparatus includes a communications interface for communicating data via a communications network and a processing resource coupled to the interface and arranged to receive a request for point of interest information, and to communicate via the communications interface a message constituting a point of interest data request for receipt by a remote server.

The document WO2011072745 “Dynamic Point of Interest Suggestion” A system, method and device for recommending a POI via a navigation device that includes receiving a recommendation of a POI from a third party at a server and determining information related to the POI. The determined information is correlated to with data related to navigation devices associated with the server. Navigation devices are selected to receive the third party recommended POI based on results of the correlation of the determined information with the data related to the navigation devices and the recommended POI is forwarded from the server to a targeted navigation device based on results of the correlation of the determined information with the data related to the navigation devices.

The document EP1939797 “Method and apparatus for automatically determining a semantic classification of context data” A method for automatically determining a semantic classification for context data obtained by a mobile device, said method comprising sampling by said mobile device one or more context data streams over time; applying a clustering algorithm to identify one or more clusters in the sampled context data; running a logic engine to automatically determine a concept name from a set of predefined concept names as a semantic classification of said one or more clusters; assigning said concept name to said one or more cluster or suggesting said assignment to the user.

Problems with Existing Solutions

As seen, Points of Interest is a term that a number of existing works refer to. Most of them use GPS data, and information about Pols is gathered from particular users, proposed and displayed, or routes between given Pols are computed. But in all the works where Pols are said to be computed, relevant locations have to be given either by the user, or by a navigation system. For instance, inventions US2009097710 and U.S. Pat. No. 7,890,254 work respectively on a method and a system for displaying point of interest. US2010121803 gathers data about previously reported locations and uses statistical analysis to present a visual guide to finding Pols at a particular time in the future, US2004236504 and WO2011072745 work on a dynamic point of interest suggestion for navigations devices, and US2011125359 consists of a point of interest data request remote system.

Based on the evaluation of user annotated data US2010023259 creates points of interests for map locations, and according to the user location US2008076451 provides a point of interest searching method while US2003191578 generates a reminder when the user is in the proximity of the point of interest. WO2011072882 also works with the location information of a point of interest and by comparing it to an associated region evaluates an attribute of the point of interest itself.

Classification techniques are applied by US2011166957 to cluster and so ensure more effective point of interest targeting among user selected locations, by WO2011076988 to group points of interest according to area names, and also by EP1939797 which provides a method for automatically determining a semantic classification for context data obtained by a mobile device.

Several references as [2][3][4][5] also work with Call Detail Records (CDRs) or GPS data [6] and build predictive models, but these are usually isolated experiments carried for a specific town and do not comprise a fully automatic detection and labelling of the most relevant locations for a user.

It has also found many inventions that are in some way related to Pols. Some of them gather information directly from the users, others record the previously visited locations (via GPS), and many are focused on POI display systems for GPS navigation.

### SUMMARY OF THE INVENTION

It is necessary to offer an alternative to the state of the art which covers the gaps found therein, particularly related to the lack of proposals which really present an efficient method to detect and label automatically and in a non-intrusive way the Pols of user mobile services.

To that end, the present invention provides a method to detect and label Pols, said method based exclusively on geo-located phone usage information and with no customer interaction.

The method of the invention comprises:
a) acquiring information from signals exchanged between a user's mobile computing devices and a plurality of Base Transceiver Stations, or BTSs;
b) analyzing said acquired information for determining, over a period of time, the locations of said user's mobile computing device based on the locations of the BTSs with which said signals exchange has occurred; and
c) detecting and labelling at least part of said user's mobile computing device determined locations as points of interest at least on the basis of the number of times said user's mobile computing device has been at said determined locations over said period of time.
   wherein said steps b) and c) comprises applying said analysis and identification through a statistical model.

This statistical model according to one embodiment comprises a Partitioning Around Medoids, or PAM, clustering algorithm based on a Pearson distance. The mentioned clustering algorithm returns twenty different representations of clusters.

The representations of clusters are represented by its medoid curve and are labelled considering social habits and cultural characteristics of the region under study.

Other features of the method of the invention are described according to appended claims 2 to 10, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows current scheme used for the location of the points of interest.

FIG. 2 shows current scheme used for the location of the points of interest worked on geo-located information.

FIG. 3 shows the different processes to be performed to estimate the statistical model.

FIG. 4 shows an example of use cases and applications that could be performed knowing users' points of interest, according to an embodiment of the present invention.

FIG. 5 shows a possible inclusion of the invention to third parties for the correct customization of their marketing campaigns or commercial activities, according to an embodiment of the present invention.

FIG. 6 shows an example of several BTS usage vector, according to an embodiment of the present invention.

FIG. 7 shows an example of set of clusters, each one represented by its medoid curve, according to an embodiment of the present invention.

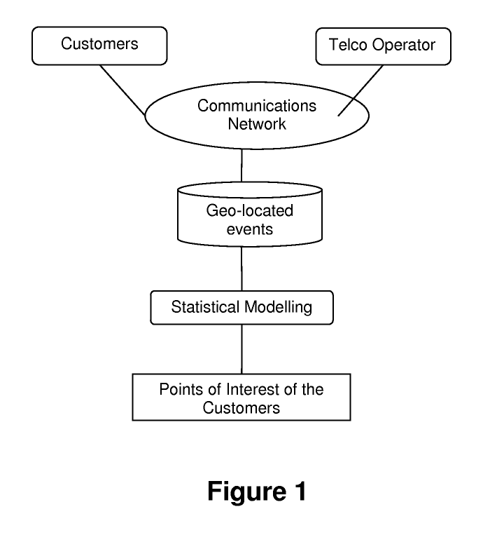

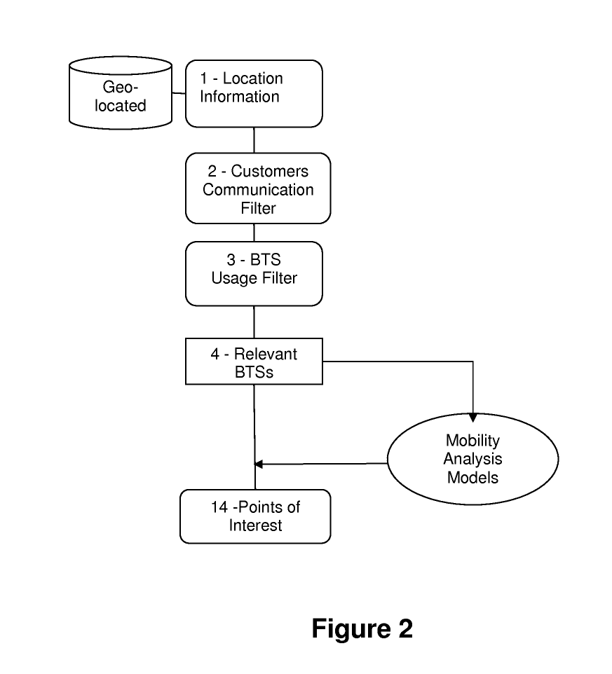

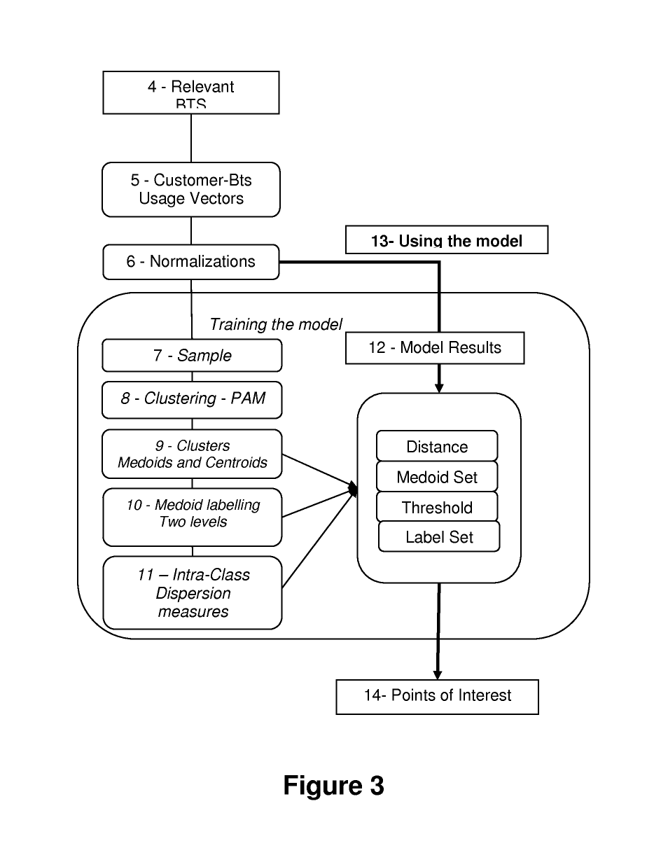

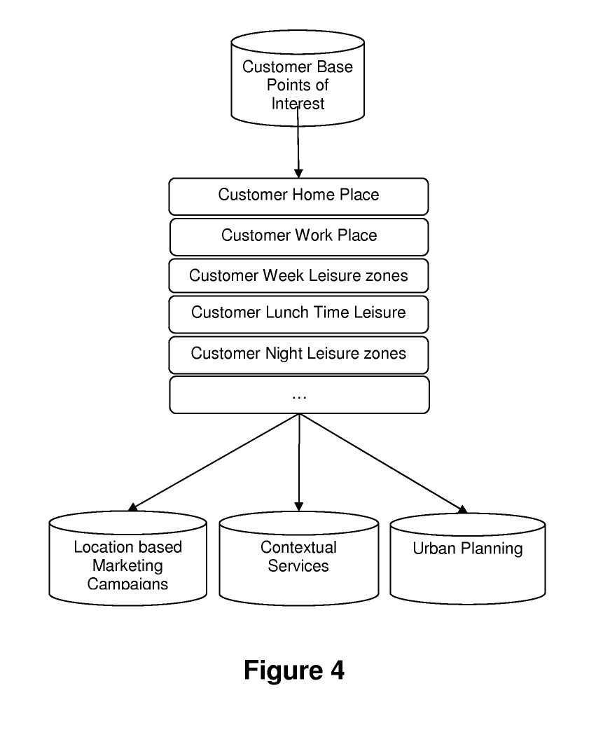

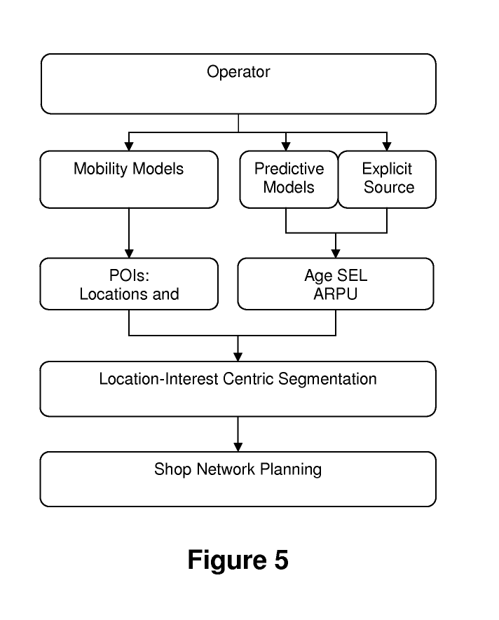

### DETAILED DESCRIPTION OF SEVERAL EMBODIMENTS

The invention works on geo-located events obtained from the operator's network in a non-intrusive way for a given period of time, capturing any geo-located traces that mobile phone usage leave on the network, from signalling (data sessions attach/detach events, initiation and termination of voice calls, SMSs sent, etc). This acquired information, i.e. geo-located events must contain at least the following information:
The number associated to the event
The date and time for the event
The BTS associated to the event

When talking about voice calls, the CDRs contain (for every customer of the operator):
The number making the call
The number receiving the call
Date and time of the call
Duration of the call
The BTS where the call begun
The BTS where the call ended

The invention consists of a series of processes that based on geo-located information lead to the points of interest of the customers that generated that geo-located information

### 1. Gathering of Location Information

By processing a certain amount of signalling traces (for instance CDRs) events are obtained (in the case of CDRs, calls) related to every customer over the period of time covered, and as we have the event date, time and BTS, we also obtain the number of events for every BTS the customer has been using over the days of the period.

Events(custX)={BTS, date}

A BTS identifier is linked to a geographical point, more precisely to the geographical area covered by the Base Transceiver Station. So, having the count of events for every BTS means that you have the count of events for every location the customer visited (every location where the customer did or received a call in the case of CDRs).

BTS=BTS(x,y)

Events(custX)=Events[cust,BTS(x,y),date(t)]=Events(cust,x,y,t)

### 2. Customer Communication Filters

This method uses statistical methods to build the Mobility Models that among other questions extract the more characteristic communication per BTS patterns across the customer base. In order to allow reliable and extendible statistical models, we filter out the cases where communication behaviour seems too extreme to be modelled, this is, customers that talk too much or too few (in general, across every location they visit), or events that might not be modelled because do not respond to a common BTS usage pattern.

This is only considering the cases where the overall communication (number of events in general) is limited by a lower and an upper threshold:

$${T}_{L} < {\sum }_{bts} {\sum }_{t} Nevents ( custX ) < {T}_{U}$$

### 3. BTS Usage Filter

For each customer it is also filtered out every BTS that does not reach a representative communication threshold T_{R} This threshold can be expressed as an absolute quantity of geo-located events, as a percentage of the customer geo-located events, or as a combination of both. For the case of a threshold given by a percentage:

$${\sum }_{t} Nevents ( custX , btsY ) > TR * {\sum }_{bts} {\sum }_{t} Nevents ( custX )$$

### 4. Relevant BTS

The Customer-BTS pairs that remain after the two filtering phases are what we call the “relevant BTSs”. For every customer we have a set of BTSs that represent the locations where the customer communicates (or registers any kind of events) at least the necessary to be modelled.

$$\begin{matrix}\begin{matrix}\begin{matrix}Cust 1 \to \{ BTS 11 , BTS 21 , … BTSn 1 \} \\ Cust 2 \to \{ BTS 12 , BTS 22 , … BTSn 2 \}\end{matrix} \\ …\end{matrix} \\ Custm \to \{ BTS 1 m , BTS 2 m , … BTSn m \}\end{matrix}$$

### Mobility Analysis Models

In order to better explain the Mobility Analysis Models a zoom-in in those components is made. The numbered boxes are explained in the following paragraphs.

### 5. Customer-BTS Usage Vectors

For every “Customer-Relevant BTS” couple, a vector containing the number of registered positions is built (calls or in general, any kind of geo-located events N_{ge}) of each of the customers at each of those BTS for every hour of the days of the week. But as not every week day has the same meaning in terms of life activity patterns, we group Monday, Tuesday, Wednesday and Thursday while Friday, Saturday and Sunday remain separated.

$$\begin{matrix}\begin{matrix}\begin{matrix}\{ Cust 1 , BTS 11 \} \to \{ \begin{matrix}\begin{matrix}{Nge}_{mt 00} , … , {Nge}_{mt 23 ,} & {Nge}_{fr 00} , … , {Nge}_{fr 23 ,}\end{matrix} \\ {Nge}_{st 00} , … , {Nge}_{st 23 ,} {Nge}_{sn 00} , … , {Nge}_{sn 23}\end{matrix} \} \\ \{ Cust 1 , BTS 21 \} \to \{ \begin{matrix}{Nge}_{mt 00} , … , {Nge}_{mt 23 ,} & {Nge}_{fr 00} , … , {Nge}_{fr 23 ,} \\ {Nge}_{st 00} , … , {Nge}_{st 23 ,} & {Nge}_{sn 00} , … , {Nge}_{sn 23}\end{matrix} \}\end{matrix} \\ …\end{matrix} \\ \{ Cust 1 , BTSn 1 \} \to \{ \begin{matrix}{Nge}_{mt 00} , … , {Nge}_{mt 23 ,} & {Nge}_{fr 00} , … , {Nge}_{fr 23 ,} \\ {Nge}_{st 00} , … , {Nge}_{st 23 ,} & {Nge}_{sn 00} , … , {Nge}_{sn 23}\end{matrix} \}\end{matrix}$$

So, for every customer several curves are obtained, as many as relevant BTS's that gather the communication pattern of that customer over its representative BTSs across the four different kinds of days. It is what we call the BTS usage vectors.

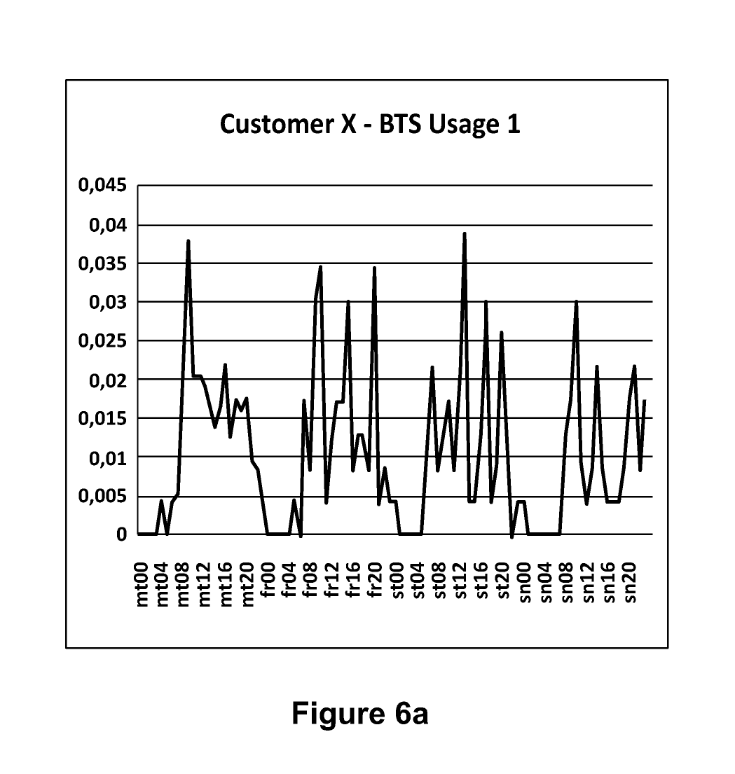

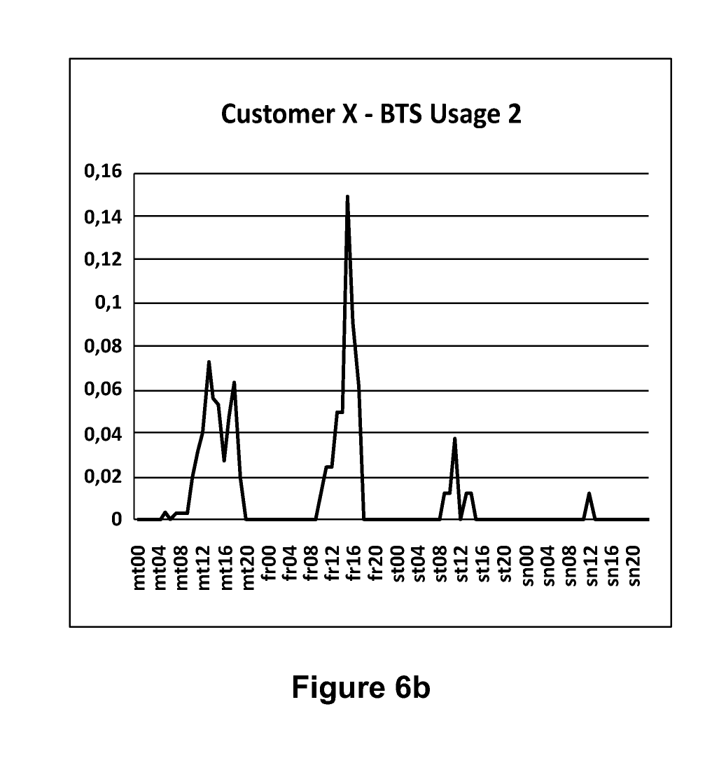

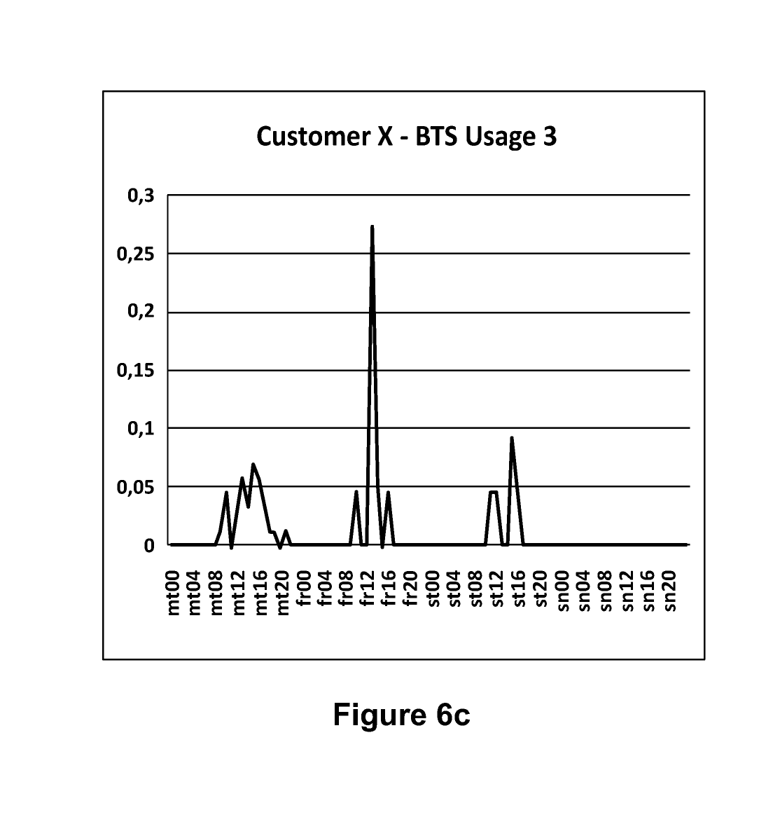

FIG. 6 shows several BTS usage vector examples. They refer to customer X, and contain the aggregated count of calls that the customer X made or received through bts1, bts2 and bts3 respectively at the 24 hour intervals from Monday to Thursday (mt00-mt23), on Fridays (fr00-fr23), Saturdays (st00-st23) and Sundays (sn00-sn23).

### 6. Normalizations

A first normalization is done dividing every value by the number of days of the corresponding type present in the period of time under consideration. This normalization allows us to compare the 4 different parts of the curves among them:

{Cust1, BTS1}′={Cust1, BTS1}/{Nmt,Nfr,Nst,Nsn}

where
Nmt is the number of Mondays, Tuesdays, Wednesdays and Thursdays over the period of time considered
Nfr is the number of Fridays over the period of time considered Nst is the number of Saturdays over the period of time considered
Nsn is the number of Sunday over the period of time considered

{Cust1, BTS1}′={Ngeₘₜ₀₀/Nmt, . . . ,Ngeₘₜ₂₃/Nmt,

Nge_{fr00}/Nfr, . . . ,Nge_{fr23}/Nfr,

Ngeₛₜ₀₀/Nst, . . . ,Ngeₛₜ₂₃/Nst,

Ngeₛₙ₀₀/Nsn, . . . ,Ngeₛₙ₂₃/Nsn }

{Cust1, BTS1}′={N′geₘₜ₀, . . . ,N′geₘₜ₂₃,

N′ge_{fr00}, . . . , N′ge_{fr23},

N′geₛₜ₁₀₀, . . . ,N′geₛₜ₂₃,

N′geₛₙ₁₀₀, . . . ,N′geₛₙ₂₃}

After this first normalization, a second one needs to be made. In order to make possible the comparison between different BTS usage curves with very different mean communication levels, and to be able to focus on the curve shape itself (and not only on the amplitude levels), the curves are also normalized dividing them by the sum of values for every point and thus giving a resultant sum equal to 1:

$${\{ Cust 1 , BTS 1 \}}^{″} = {\{ Cust 1 , BTS 1 \}}^{′} / {\sum }_{i = 0}^{95} {N}^{′} {ge}_{i} = {\{ Cust 1 , BTS 1 \}}^{′} / {N}^{′} t$$

$${\{ Cust 1 , BTS 1 \}}^{″} = \{ \begin{matrix}{N}^{′} {ge}_{mt 00} / {N}^{′} t , … , {N}^{′} {ge}_{mt 23} / {N}^{′} t , \\ {N}^{′} {ge}_{fr 00} / {N}^{′} t , … , {N}^{′} {ge}_{fr 23} / {N}^{′} t , \\ {N}^{′} {ge}_{st 00} / {N}^{′} t , … , {N}^{′} {st}_{23} / {N}^{′} t , \\ {N}^{′} {ge}_{sn 00} / {N}^{′} t , … , {N}^{′} {ge}_{sn 23} / {N}^{′} t\end{matrix} \}$$

$$Where$$

$${N}_{t}^{′} = {\sum }_{i = 0}^{95} {N}^{′} {ge}_{i} = {\sum }_{i = 0}^{23} {N}^{′} {ge}_{mtj} + {\sum }_{k = 0}^{23} {N}^{′} {ge}_{frk} + {\sum }_{i = 0}^{23} {N}^{′} {ge}_{stl} + {\sum }_{m = 0}^{23} {N}^{′} {ge}_{snm} \text{?} {N}^{′} t = {\sum }_{i = 0}^{95} {N}^{′} {ge}_{i}$$

$$\text{?} \text{indicates text missing or illegible when filed}$$

### 7. Sample

A representative sample of the normalized BTS usage vectors is then extracted to feed a non-supervised classification method to identify the main classes of BTS Usage Patterns.

### 8. Clustering

There are several possible implementations for the classification method; one option is to use a clustering algorithm as for example, a partitioning around medoids (PAM) method based on a Pearson distance.

### PAM Clustering

The Partitioning Around Medoids (PAM) clustering can be considered a more robust version of the classical k-means approach. It is described in Chapter 2 of the book “Finding Groups in Data: An Introduction to Cluster Analysis”, Kaufman & Rousseeuw, 1990.
It has some desirable features:
   It can work directly on a set of data, but it also accepts a dissimilarity matrix of those data as input
   It is more robust than k-means because it minimize a sum of dissimilarities instead of a sum of squared Euclidean distances

The PAM algorithm is based on the search for k representative objects (medoids) among the observations of the dataset. These observations should represent the structure of the data. After finding a set of k medoids, k clusters are constructed by assigning each observation to their closest representative object, based on a given distance. In the case of our invention a Pearson distance is used. A medoid can be defined as that object of a cluster whose average dissimilarity to all the objects in the cluster is minimal.

By default, the initial set of medoids is not specified. The algorithm first looks for a good initial set of medoids (build phase). Then it finds a local minimum for the objective function (swap phase).

### Pearson Distance

If we have samples of two variables X and Y, it is very common to calculate the sample Pearson correlation coefficient to reveal if there is a linear relationship between the two variables:

$$r = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}}$$

This coefficient is always between −1 and 1. It is 1 if there is a perfect positive linear relation between the two variables, and is −1 if there is a perfect negative linear relation.

An equivalent expression gives the correlation coefficient as the mean of the products of the standard scores:

$$r = \frac{1}{n - 1} {\sum }_{i = 1}^{n} ( \frac{{X}_{i} - \overline{X}}{{s}_{x}} ) ( \frac{{Y}_{i} - \overline{Y}}{{s}_{y}} )$$

where sx and sy are the sample standard deviation of X and Y.

Pearson correlation can be taken as a measure of similarity between the paired data (Xi, Yi). So we can also obtain a correlation based distance as an expression of the dissimilarity between those data vector:

d=1−r

The greatest value of this distance will be 2 when the vectors can be considered “opposite”, and the lowest values will be 0 when the vectors can be considered as having the same shape or profile (if represented in sequence).

The invention uses a PAM clustering method based on a Pearson distance to group the different {Cust, BTSi} curves in several classes following an unsupervised strategy.

The output of the clustering method is a set of classes of BTS usage vectors, each of the classes represented by its medoid. The resulting classes must be as different as possible among them but the vectors belonging to the same class must be as similar as possible. Similarities are considered according to the given distance, in this case the Pearson's one.

### 9. Clusters, Medoids and Centroids

The clustering process aims to cover as much variability as possible in the sense of detecting many different groups for the Relevant BTS communication patterns. This is why we initially work with a relatively high number of clusters.

For instance, in one of the implementations, the clustering algorithm is forced to return 20 different classes.

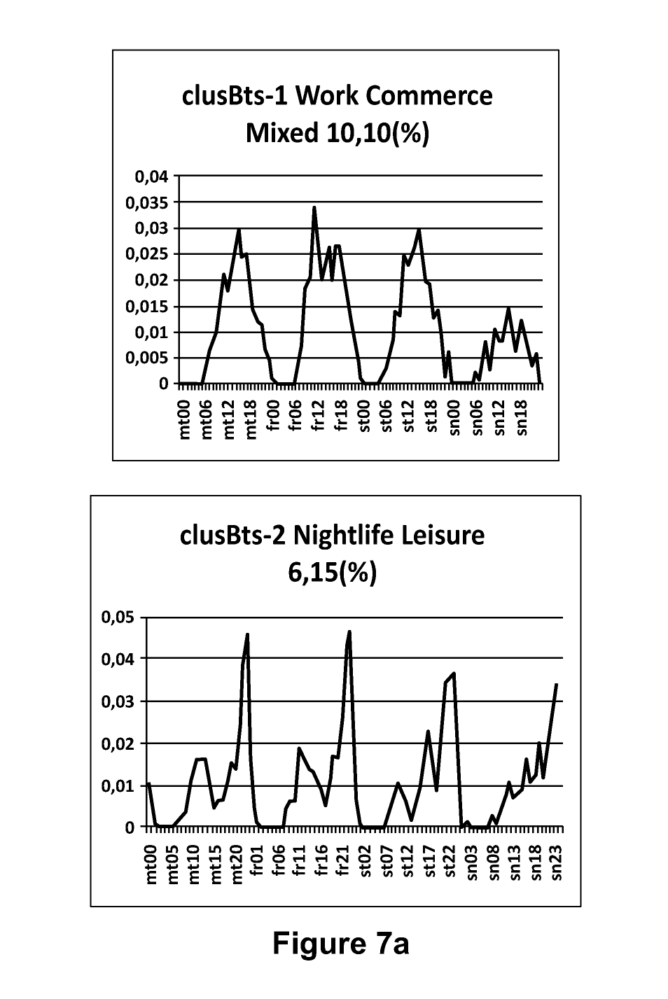

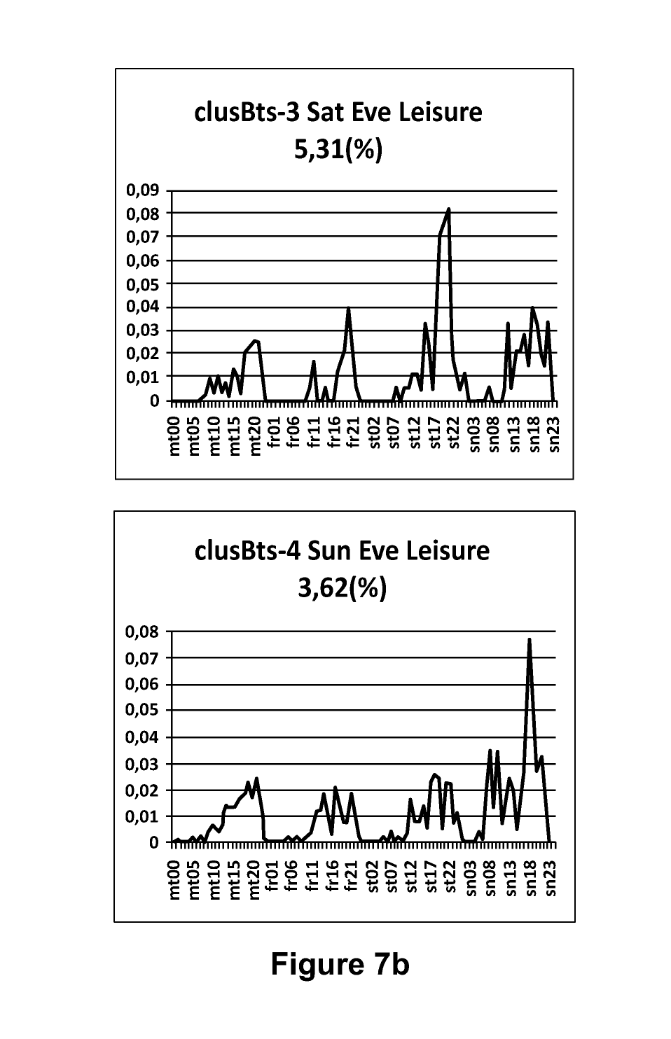

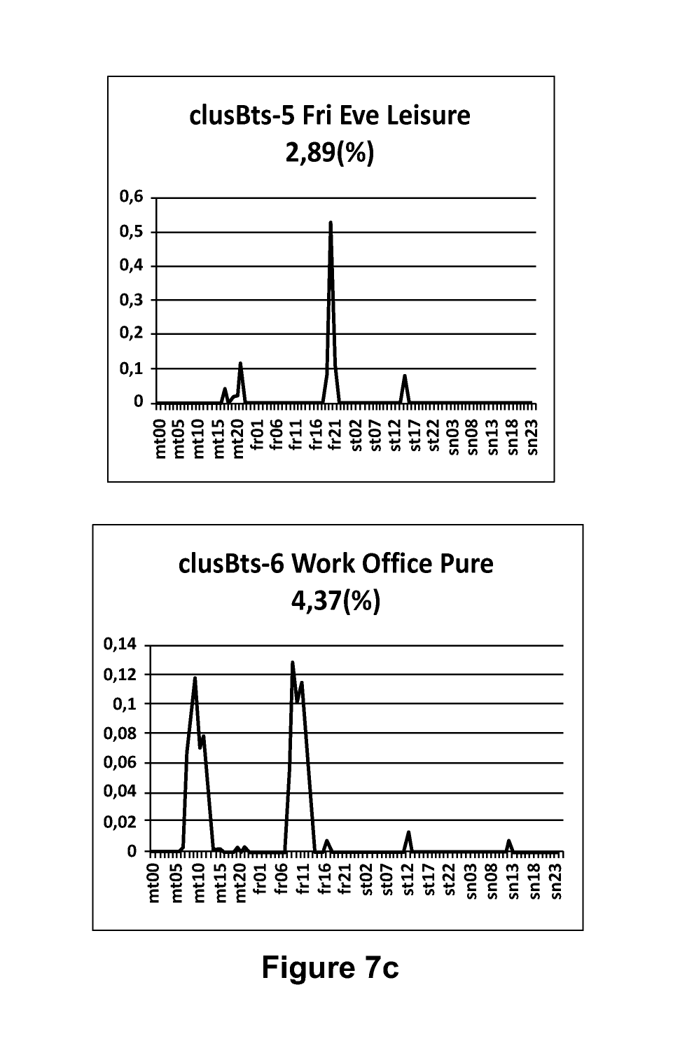

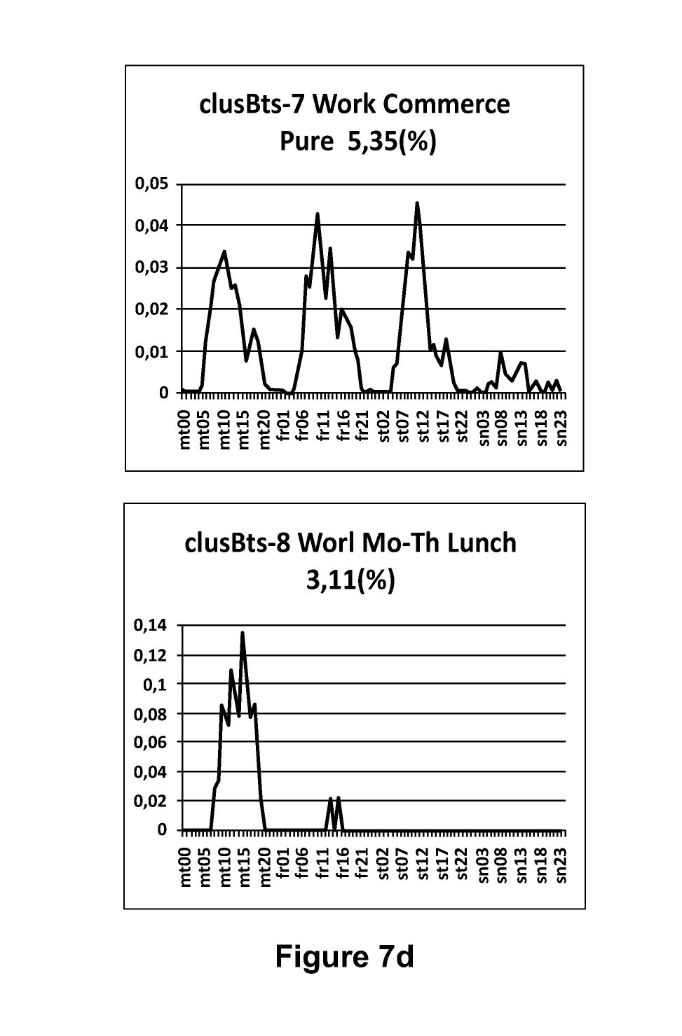

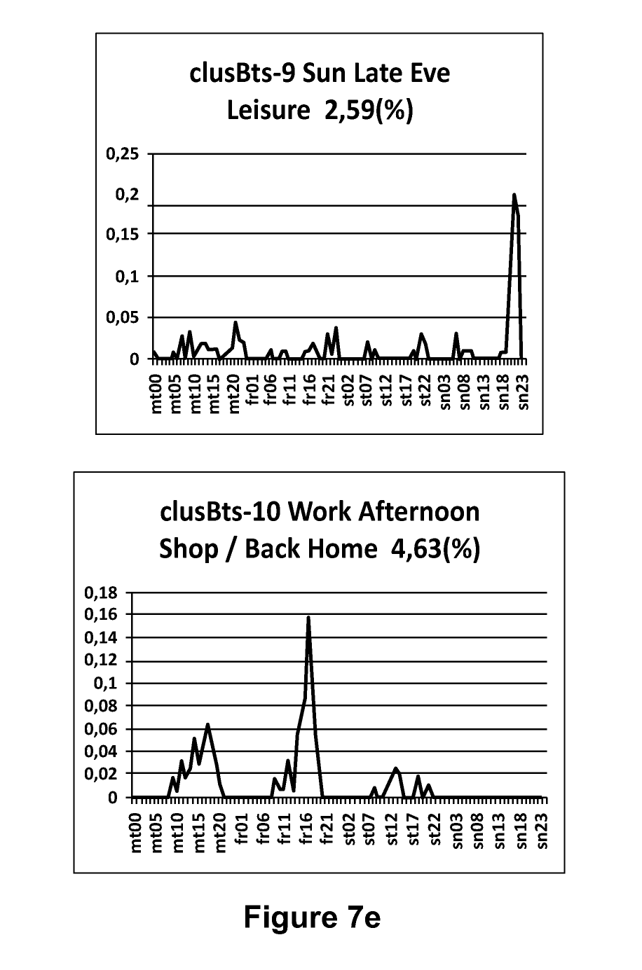

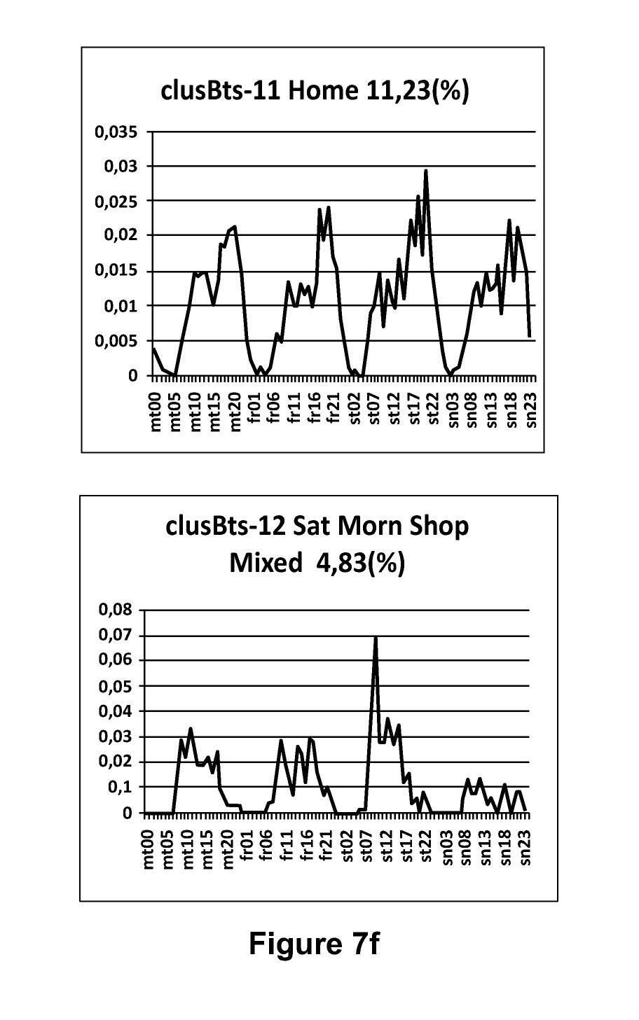

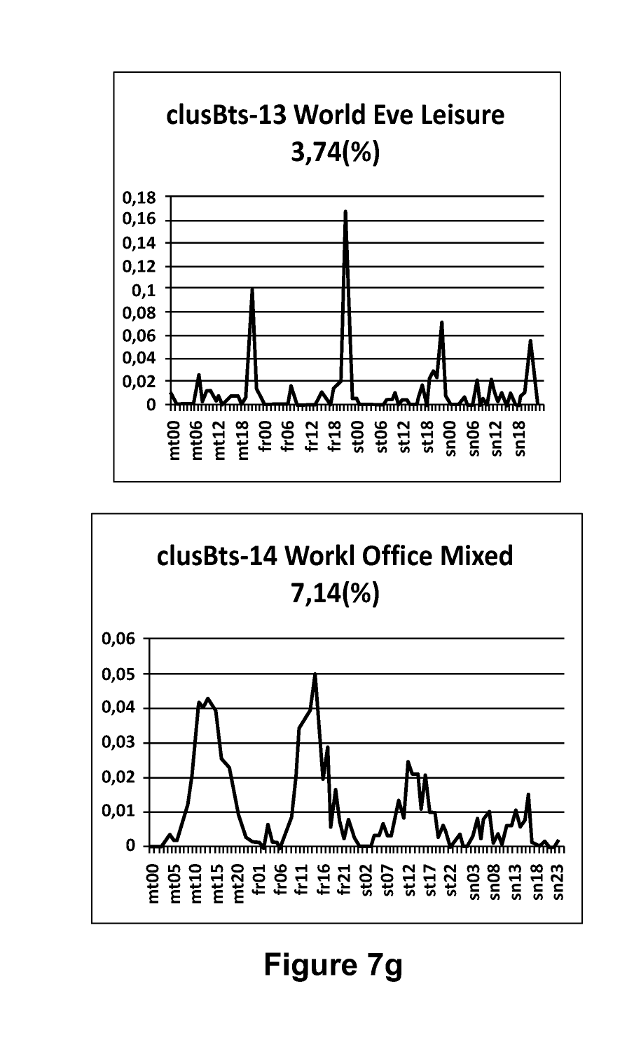

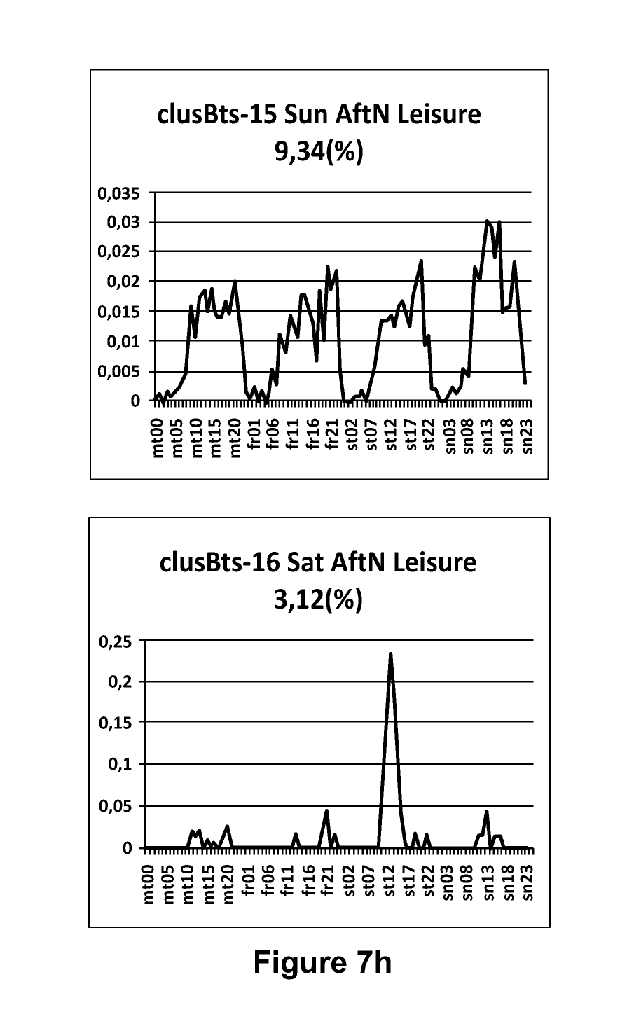

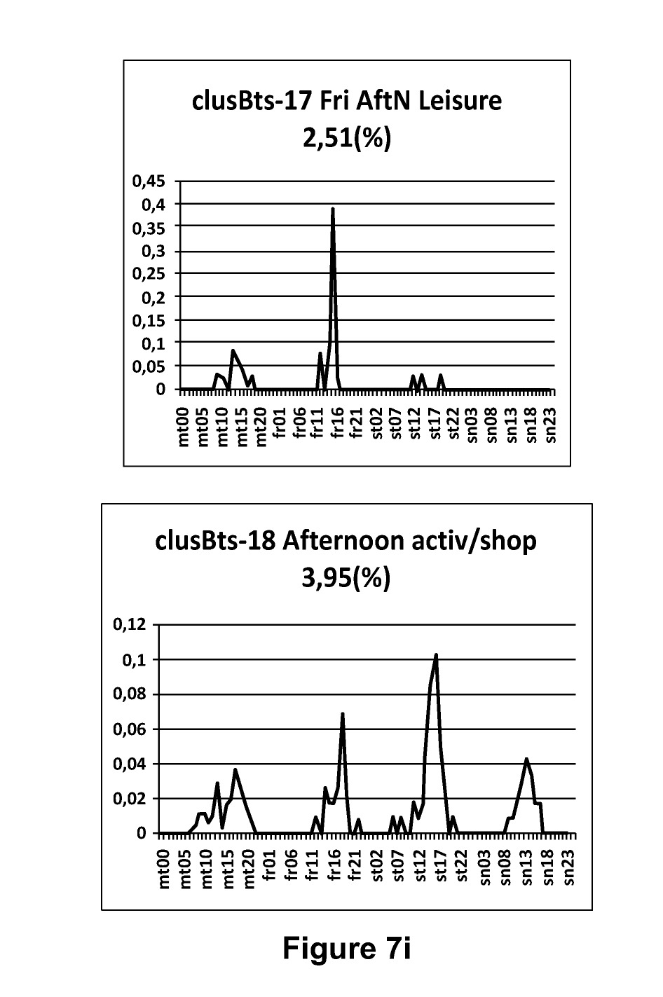

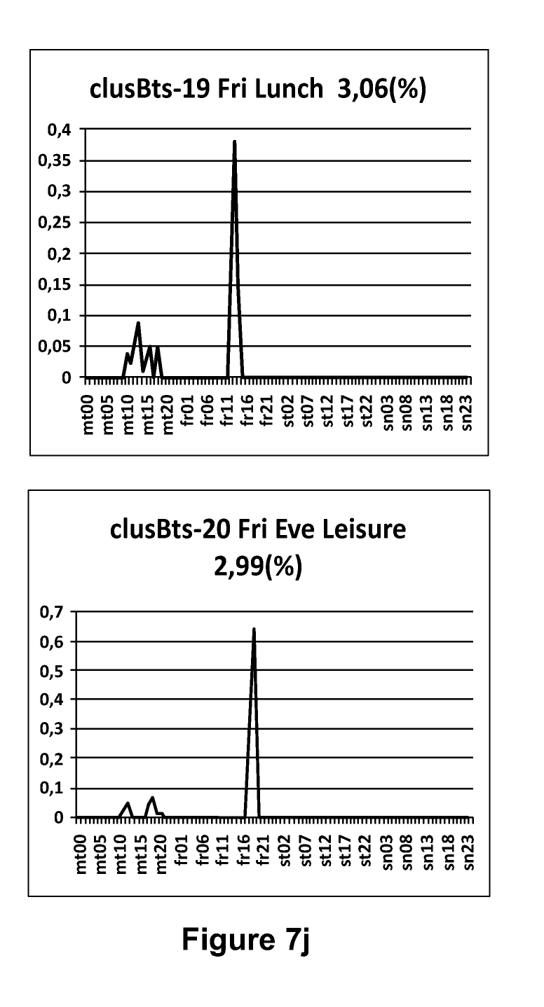

FIG. 7 shows a set of clusters, each one represented by its medoid curve.

### 10. Medoid Labelling

Once the medoid and centroid are obtained for each class a different label is assigned to them taking into account the social habits and cultural characteristics of the region under study. In this case the algorithm would give 20 different labels for “level 0” labels (the wider set of labels). Looking at the patterns of the class representatives we later group them into 5 “level 1” labels.

The following text-box shows an example set of level 0 labels created for the BTS-Usage clusters:

| | |
|---|---|
| 1 | work (commercial afternoon) |
| 2 | nightlife leisure |
| 3 | Saturday evening leisure |
| 4 | Sunday evening leisure |
| 5 | Friday evening leisure |
| 6 | work (office, morning) |
| 7 | work (commercial) |
| 8 | work Mo-Th (lunch time) |
| 9 | Sunday late evening leisure |
| 10 | work days afternoon shopping |
| 11 | home |
| 12 | Saturday morning shopping |
| 13 | work days evening leisure |
| 14 | work (afternoon) |
| 15 | Sunday afternoon leisure |
| 16 | Saturday afternoon leisure (shopping) |
| 17 | Friday afternoon shopping |
| 18 | afternoon shopping |
| 19 | Friday afternoon shopping (Friday lunch, leaving home) |
| 20 | Friday evening leisure |

And as previously mentioned, a “level 1” set of labels is created thinking on practical applications that would not need such detail:

| | |
|---|---|
| 1 | office work |
| 2 | commercial work |
| 3 | home/evening leisure |
| 4 | night/evening leisure |
| 5 | afternoon leisure/shopping |

### 11. Intra-Class Dispension Measures

The Pearson distance to the cluster representative (medoid) is analyzed for every cluster, to obtain the average and the standard deviation of the distance to the cluster centre for every classified item. Such values are later used to decide about the POI classification accuracy, to see whether to assign a Point of Interest label or not.

### 12. Model Results

The distance
   A function implementing the distance, needed to be applied every time we want to automatically assign a POI label to a new instance (normalized communication vector)
Medoid Set:
   Cluster representatives: 96 position vectors
Threshold Set
   Average distance inside each cluster
   Distance standard deviation
Label Set (P01 labels)
   Level 0 label sets
   Level 1 label sets
   Correspondence table

### 13. Using the Model

For any Customer-BTS usage vector (present in the sample or not) we assign the “level 0” label of the closest centroid in terms of the same distance that has been used in the clustering process (in this case the Pearson distance).

The equivalent “level 1” label is also assigned based on the knowledge of the “level 0” label and on the correspondence table. For some cases, the instance (customer-BTS usage vector that is being automatically labelled) and the centroid are very similar and the “level 0” labels are a good choice. But this does not always happen, and the level 1 labels represent a more general labelling, with a lower error margin.

One possibility of assigning the labels is to use the value of the average distance and the distance standard deviation to obtain a threshold to decide which of the labels should be used.

For instance, if

ti Distance({Cust,BTSi},Centroid)>Avg(distance)+stdDev(distance)
then the vector is far from the cluster centre, so it's not reliable enough and we might not want to provide that label. For that case we could for instance return a code that implies that the cluster and label obtained are not reliable enough.
For the cases where

Avg(distance)<Distance({Cust,BTSi},Centroid)<Avg(distance) +stdDev(distance)

It can be said that the vector is nor too far neither too close from the cluster centre. In this case we could consider the assigned cluster is not reliable enough to return the level 0 label and could instead consider only the level 1 label.

And for the rest of the cases where

Distance({Cust,BTSi},Centroid)<Mean(distance)

The vector is close enough to the cluster centroid and the level 0 label seems to be an acceptable solution for the automatic point of interest labelling process.

This invention allows a customer to have several POIs with the same label. In some cases, we can modify one of those labels producing new specialized level 1 labels. For instance, a customer may have more than one location labelled as “home”. Taking into account other information as the usual area of activity of the customer during week days and week ends, and calculated over the given period of time, one of those POIs can be labelled as “2^{nd} residence”. In these cases the initial level 1 labels set is expanded by the addition of new specialized labels.

### 14. Point of Interest

Finally, as an output of our invention we obtain for every customer:
A set of BTS that are of special interest for the customer, each one automatically labelled. Those labels explain the particular meaning of the locations for that particular customer.

### EXAMPLE OF SEVERAL EMBODIMENTS

The knowledge of our customers' points of interest enables a wide variety of use cases and applications.

Knowing the places our customers live, work and prefer for their leisure activities at the different hours of the week allows the operator to develop specific services and applications that exploit such location-segmented information.

That information can also be provided to institutions that might find it useful for any public service planning such us public transport network designing, disease spread control, or other public initiative based on the knowledge of citizens' points of interest.

And other third parties (companies) can also be interested in the use of the points of interest for the correct customization of their marketing campaigns or commercial activities.

Imagine a big textile company that sells different kinds of clothes for the different segments, where segments can be defined by the crossed age and socio-economic level (SEL). That company then is really interested in knowing which locations are of the interest of the teenagers to decide where to locate shops that sell clothes for that segment. Similarly, that company is also very interested in knowing which places are visited through the daily routes of people in their thirties with a probably higher purchasing power. The purchasing power could be correlated with the ARPU (average revenue per user).

So, the information automatically generated by the invention can be sold to 3^{rd} parties or combined with other predictive models inside the operator to support (as in this use case) the shop network designing process (based on the mixed used of the locations of interest of our customers and the more traditional segments as age, SEL or ARPU).

### ADVANTAGES OF THE INVENTION

This invention takes input information that is already available in the usual activity of a telecommunications operator, so no special processes have to be developed in order to obtain it.

This invention allows a fully automatic obtainment of the points of interest of the customers, both individually and at a global and aggregated fashion.

This invention is a non-intrusive method, so the users are not disturbed or bothered from their activity while communicating.

This invention can be easily extended to incorporate new features and can also be extended or applied to any regions.

This invention allows the developments of new and disruptive services that take into account the knowledge of the locations a user goes into, and what they mean for them.

### ACRONYMS

POI Point of Interest
BTS Base Transceiver Station
CDR Call Detail Record
GPS Global Positioning System
SMS Short Message Service

### REFERENCES

[1] González, Hidalgo, Barabási (2008) Understanding individual mobility patterns. Nature, 453, 779-782

[2] Song, C., Qu, Z., Blumm, N. and Barabási, A-L. (2010). Limits of Predictability in Human Mobility. Science, 327, 1018-1021.
[3] Calabrese, Di Lorenzo, Ratti (2010) Human Mobility Prediction based on Individual and Collective Geographical Preferences. ITSC
[4] Firouzi, Liu. Sadrpour (2009) Mobility Pattern Prediction Using Cell-phone Data logs. EECS Final Project Report.
[5] Candia, González, Wang, Schoenharl, Madey, Brabási (2008) Uncovering

Individual and Collective Human Dynamics from Mobile Phone Records. Journal of Physics A: Mathematical and Theoretical 41
[6] Zignani, Gaito (2010) Extracting Human Mobility Patterns From GPS-based Traces. 978-1-4244-9229-9/10/$26.00 ©2010 IEEE
[7] Phithakkitnukoon, Horanont, Di Lorenzo, Shibasaki, Ratti (2010) Activity

Aware Map: Identifying Human Daily Activity Pattern Using Mobile Phone Data. LNCS 6219, pp. 14-25
[8] Boldrini, Conti, Passarella (2009) The Sociable Traveller: Human Travelling Patterns in Social-Based Mobility. MobiWac'09, October 26-27, 2009, Tenerife, Canary Islands, Spain.

1. A method for automatic detection and labelling of user points of interest, comprising:
d) acquiring information from signals exchanged between a user's mobile devices and a plurality of Base Transceiver Stations, or BTSs;
e) analyzing said acquired information for determining, over a period of time, the locations of said user's mobile computing device based on the locations of the BTSs with which said signals exchange has occurred; and
f) identifying and labelling at least part of said user's mobile computing device determined locations as points of interest at least on the basis of the number of times said user's mobile computing device has been at said determined locations over said period of time.
wherein said steps b) and c) comprises applying said analysis and identification through a statistical model.

2. The method of claim 1, further comprising limiting said acquiring information from user's mobile computing device by a lower and an upper threshold.

3. The method of claim 1, further comprising filtering each of said BTS for each of said user mobile computing device when the communication between them is lower than a threshold.

4. The method of claim 1 to 3, wherein said acquiring information of step a) further comprising for each couple user-relevant BTS, a vector containing said locations for every hour of the days of the week.

5. The method of claim 1, wherein said statistical model further comprises a Partitioning Around Medoids, or PAM, clustering algorithm based on a Pearson distance.

6. The method of claim 5, wherein said clustering algorithm returns twenty different representations of clusters.

7. The method of claim 6, wherein said representations of clusters are represented by its centroid curve and are labelled considering social habits and cultural characteristics of the region under study.

8. The method of claim 7, wherein a first set of 20 labels are used to identify points of interest taking into account said habits and said cultural characteristics of the region.

9. The method of claim 8, wherein from said first set of 20 labels a second set of 5 labels are used to identify said points of interest based on practical applications.

10 The method of claim 1, wherein said acquiring information of said step a) includes the number of said user mobile computing device, the date and time, and the BTS associated to said signals exchanged.

11. A method for automatic detection and labelling of user points of interest, comprising:
a) acquiring information from signals extracted from a user's mobile computing device;
b) analyzing said acquired information for determining, over a period of time, the locations of said user's mobile computing device; and
c) identifying and labelling at least part of said user's mobile computing device determined locations as points of interest at least on the basis of the number of times said user's mobile computing device has been at said determined locations over said period of time
the method being characterized in that:
the signals extracted in step a) are signals exchanged between the user's mobile computing device and a plurality of Base Transceiver Stations, or BTSs; and
the locations of the user's mobile computing device in step b) is based on the locations of the BTSs with which said signals exchange has occurred,
wherein said steps b) and c) comprises applying said analysis and identification through a statistical model.

12. The method of claim 11, further comprising limiting said acquiring information from user's mobile computing device by a lower and an upper threshold.

13. The method of claim 11, further comprising filtering each of said BTS for each of said user mobile computing device when the communication between them is lower than a threshold.

14. The method of claim 11, wherein said acquiring information of step a) further comprising for each couple user-relevant BTS, a vector containing said locations for every hour of the days of the week.

15. The method of claim 11, wherein said statistical model further comprises a Partitioning Around Medoids, or PAM, clustering algorithm based on a Pearson distance.

16. The method of claim 15, wherein said clustering algorithm returns twenty different representations of clusters.

17. The method of claim 16, wherein said representations of clusters are represented by its centroid curve and are labelled considering social habits and cultural characteristics of the region under study.

18. The method of claim 17, wherein a first set of 20 labels are used to identify points of interest taking into account said habits and said cultural characteristics of the region.

19. The method of claim 18, wherein from said first set of 20 labels a second set of 5 labels are used to identify said points of interest based on practical applications.

20. The method of claim 11, wherein said acquiring information of said step a) includes the number of said user mobile computing device, the date and time, and the BTS associated to said signals exchanged.
